(19) United States
(12) Patent Application Publication
(10) Pub. No.: US 2009/0160871 A1
(43) Pub. Date: Jun. 25, 2009

(54) IMAGE PROCESSING METHOD, IMAGE DATA CONVERSION METHOD AND DEVICE THEREOF

(75) Inventors: Ching-Fu Hsu, Taichung County (TW); Chih-Chang Lai, Taichung County (TW); Jyun-Sian Li, Tainan City (TW); Ruey-Shing Weng, Kaohsiung City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: WINTEK CORPORATION, Taichung (TW)

(21) Appl. No.: 12/339,168

(22) Filed: Dec. 19, 2008

(30) Foreign Application Priority Data
Dec. 21, 2007 (TW) 96149240

(51) Int. Cl. G09G 5/02

(52) U.S. Cl. 345/589

(57) ABSTRACT

An image data conversion method is provided. The method comprises the following steps of (a) receiving an original image data having three basic-color sub-pixel data and (b) calculating at least one color-enhancing sub-pixel data according to any two basic-color sub-pixel data so as to convert the original image data into an image data having at least three basic-color sub-pixel data and one color-enhancing sub-pixel data. The calculation of the color-enhancing sub-pixel data is represented as:

$${J}_{i} = [ var . - ( \frac{\vert {D}_{i} - {E}_{i} \vert}{S} ) ] \times Max ( {D}_{i} , {E}_{i} )$$

wherein
   0.8<var.<1.2,
   Dᵢ, Eᵢ: two basic-color sub-pixel data
   S: the maximal grey level

This application claims the benefit of Taiwan application Serial No. 96149240, filed Dec. 21, 2007, the subject matter of which is incorporated herein by reference.

### BACKGROUND OF THE INVENTION

1. Field of the Invention

The invention relates in general to an image processing method, and more particularly to an image data conversion method for image processing method and a device thereof.

2. Description of the Related Art

In recent years, liquid crystal display (LCD) panel has come out with a new model in which a single pixel is formed by four sub-pixels. That is, a yellow sub-pixel is added in addition to the original red (R) sub-pixel, green sub-pixel and (B) blue sub-pixel. As every pixel of such RGBY display panel is formed by mixing the light of four colors, color saturation is increased and color gamut is expanded. Therefore, the RGBY display panel has become a mainstream display product.

A commonly seen RGBY display is formed by adding a yellow sub-pixel to a conventional three-color RGB pixel array without changing the area of the pixel. However, the area of every sub-pixel is reduced to ¾ of the original area, and the aperture ratio is decreased as well. Besides, the display panel needs to use a large amount of data lines and data driving chips to drive the new added yellow sub-pixel.

Another commonly seen RGBY display is formed by adding a yellow sub-pixel to a conventional three-color RGB pixel array without changing the area of the sub-pixel. Despite the aperture ratio is maintained, resolution deteriorates. This is because given the area of the display being fixed, the number of pixels decreases and resolution deteriorates when the area of the pixel increases.

A modified pixel array having the same RGBY sub-pixel is provided to resolve the above problems of having a decreased aperture ratio and a smaller quantity of driving lines. Referring to FIG. 1, a perspective of a modified stripe yellow type is shown. The modified stripe yellow type (MSY type) comprises many rows of red sub-pixel (R), green sub-pixel (G), blue sub-pixel and yellow sub-pixel (Y), wherein three consecutive sub-pixels in each row form a pixel. Let a selected pixel unit be the pixel unit 3 denoted by bold lines in the diagram. Before driving the pixel unit 3, the image data having the value of RGB sub-pixel is converted to the format of RGBY four-color data, wherein the yellow sub-pixel data Yᵢ=Min(Rᵢ, Gᵢ) is the minimal value of the red sub-pixel data and the green sub-pixel data. As the pixel unit 3 lacks the yellow sub-pixel (Y), the yellow sub-pixel surrounding the top, the bottom, the left and the right of the pixel unit 3 will be driven according to the calculated weighted values to achieve color compensation. The actually outputted value of the yellow sub-pixel data surrounding the top, the bottom, the left and the right of the pixel unit 3 is the average value Yᵤₚ₋ₒᵤₜₚᵤₜ=(Y₃+Yᵤₚ)/2 of the yellow sub-pixel data of the neighboring pixel and the yellow sub-pixel data of the pixel unit 3. Thus, the resolution of the original image is maintained without using additional driving lines or driving chips.

However, if the minimal value of the red sub-pixel data and the green sub-pixel data is used as the actually outputted value of the yellow sub-pixel data, the expansion in color gamut will be very limited. Also, if the average value of the sub-pixel data shared by two neighboring pixels is used as the actually outputted value, edge blur will occur when processing the borders or texts which have strong contrast with their neighboring pixels. For example, when the average the interface between a black block and a white block is displayed according to the above average method, a gray interface will be generated between the black block and the white block. As a result, image contrast decreases, image sharpness plummets and image distortion worsens.

### SUMMARY OF THE INVENTION

The invention is directed to an image data conversion method and a device thereof. The extracted color-enhancing sub-pixel data not only expands color gamut but also maintains pure-color display effect.

The invention is directed to an image processing method. The minimal value of the sub-pixel data of a pixel and the color-compensating sub-pixel data of a neighboring pixel is used as the actually outputted sub-pixel data value so as to maintain the contrast and the sharpness of an image.

According to a first aspect of the present invention, an image data conversion method is provided. The method comprises the following steps of (a) receiving an original image data having three basic-color sub-pixel data and (b) calculating at least one color-enhancing sub-pixel data according to any two basic-color sub-pixel data so as to convert the original image data into an image data having at least three basic-color sub-pixel data and one color-enhancing sub-pixel data, wherein the calculation of the color-enhancing sub-pixel data is represented as:

$${J}_{i} = [ var . - ( \frac{\vert {D}_{i} - {E}_{i} \vert}{S} ) ] \times Max ( {D}_{i} , {E}_{i} ) \qquad ( 1 )$$

wherein var.=0.8˜1.2; Dᵢ, Eᵢ is two basic-color sub-pixel data; S is the maximal grey level.

According to a second aspect of the present invention, an image processing method is provided. The method comprises the following steps:

(a) Receiving the original image data having the three basic-color sub-pixel data;

(b) Calculating at least one color-enhancing sub-pixel data according to any two basic-color sub-pixel data so as to convert the original image data into an image data having at least three basic-color sub-pixel data and one color-enhancing sub-pixel data. The calculation of the color-enhancing sub-pixel data is represented as:

$${J}_{i} = [ var . - ( \frac{\vert {D}_{i} - {E}_{i} \vert}{S} ) ] \times Max ( {D}_{i} , {E}_{i} ) \qquad ( 1 )$$

wherein var.=0.8˜1.2; Dᵢ, Eᵢ are any two basic-color sub-pixel data of the original image data; S is the maximal grey level;

(c) Forming a display pixel array by the three basic-color sub-pixels and the at least one color-enhancing sub-pixel and forming a selected pixel by any three of the sub-pixels, wherein the converted image data comprises a first value belonging to the sub-pixel color of the selected pixel and a second value not belonging to the sub-pixel color of the selected pixel;

(d) Receiving a third value inputted from the at least one neighboring selected pixel by the selected pixel, wherein the third value does not belong to the neighboring sub-pixel color of the selected pixel but belongs to the sub-pixel color of the selected pixel;

(e) Using the minimal value of the first value and the third value as the data value of the sub-pixel color outputted from the selected pixel when the sub-pixel color corresponding to the third value is identical to the sub-pixel color corresponding to the first value; and

(f) Using the first value as the data value of the sub-pixel of remaining color outputted from the selected pixel.

According to a third aspect of the present invention, an image data conversion device is provided. The device comprises a first subtractor, an absolute value extractor, a divider, a second subtractor, the maximal value extractor, and a multiplier. The first subtractor is used for receiving three basic-color sub-pixel data of the original image data and selecting any two basic-color sub-pixel data and calculating the difference between the two selected sub-pixel data. The absolute value extractor is used for receiving the difference and taking the absolute value of the difference. The divider is used for receiving the absolute value and dividing the absolute value by the maximal grey level to obtain a quotient. The second subtractor is used for calculating the difference between a variable and the quotient, and the difference is regarded as a parameter, wherein the variable ranges between 0.8˜1.2. The maximal value extractor is for taking the maximal of two basic-color sub-pixel data. The multiplier is for multiplying the maximal of two basic-color sub-pixel data by the parameter and using the product as the color-enhancing sub-pixel data.

The invention will become apparent from the following detailed description of the preferred but non-limiting embodiments. The following description is made with reference to the accompanying drawings.

### BRIEF DESCRIPTION OF THE DRAWINGS

FIG. 1 shows a perspective of a modified stripe yellow type;

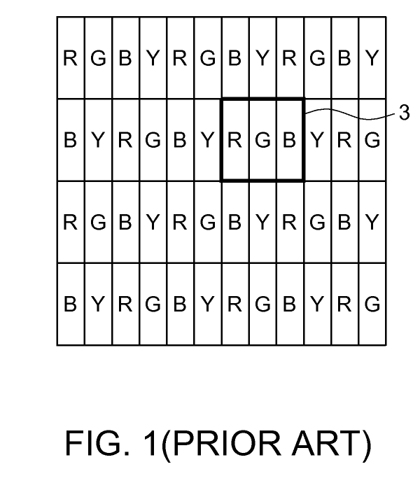

FIG. 2 shows a block diagram of an image data conversion device according to a first embodiment of the invention;

FIG. 3 shows a perspective of a display pixel array according to a first embodiment of the invention;

FIG. 4 shows a perspective of pixel data sharing according to a first embodiment of the invention;

FIG. 5 shows a perspective of an image processing method according to a first embodiment of the invention;

FIG. 6 shows a display pixel array according to a second embodiment of the invention;

FIG. 7 shows a perspective of pixel data sharing according to a second embodiment of the invention;

FIG. 8 shows a perspective of an image processing method according to a second embodiment of the invention;

FIG. 9 shows a perspective of pixel data sharing according to a third embodiment of the invention; and

FIG. 10 shows a perspective of an image processing method according to a third embodiment of the invention.

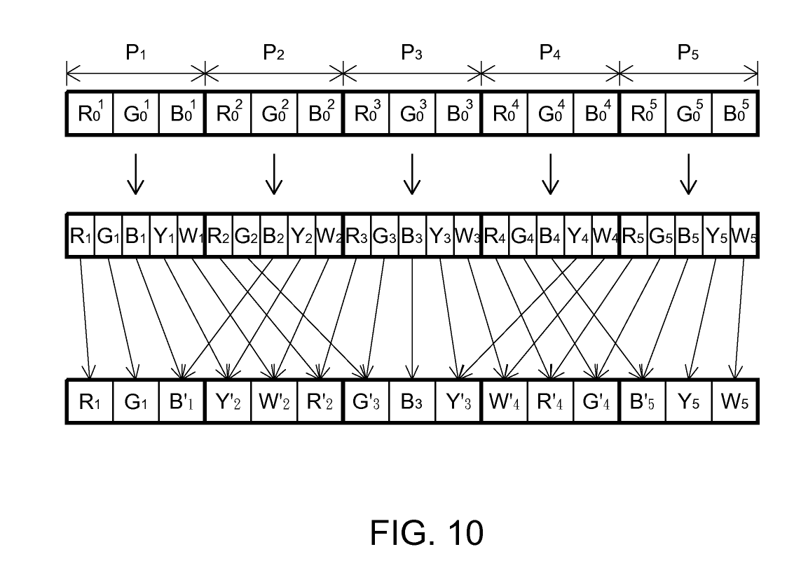

### DETAILED DESCRIPTION OF THE INVENTION

The invention provides an image processing method, converting an original image data (three-color data) into an image data format having more than three colors, to go with a display having a specific pixel array. The re-defined pixel and the neighboring pixel share the converted image data, and the image data undergoing the process above is further used as actually outputted value. Thus, the resolution is maintained and the color gamut is expanded without additional driving lines and driving chip. Under such structure, the following embodiments are disclosed.

### First Embodiment

The first embodiment of the invention provides an image processing method, converting an original image data of three-color into a four-color data, to go with a display having a specific pixel array. The re-defined pixel and the neighboring pixel share the converted image data, and the image data undergoing the process above is further used as actually outputted value. Thus, the resolution is maintained and the color gamut is expanded without adding additional driving lines and driving chip. Under such structure, an image data conversion method, a device thereof and a sub-pixel data sharing method are further provided in the present embodiment of the invention so as to expand the color gamut and increase the sharpness of the texts.

The original image data, which is normally denoted by the value of three primal colors, comprises three basic-color sub-pixel data Dᵢ, Eᵢ, Fᵢ. Examples of the three basic-color sub-pixels include a red (R) sub-pixel, a green (G) sub-pixel and a blue (B) sub-pixel, or a cyan (C) sub-pixel, a magenta (M) sub-pixel and a yellow (Y) sub-pixel. The image data conversion method of the present embodiment of the invention converts a three-color data into a four-color data, in which the added color is preferably a mixed color of any two of the three basic colors, and the data value of the added color is preferably obtained from the calculation of co-relation between any two basic-color sub-pixel data of the original image data.

In details, the color-enhancing sub-pixel data Jᵢ obtained from the calculation of any two basic-color sub-pixel data Di and Ei of the original image data Dᵢ, Eᵢ and Fᵢ is represented as:

$${J}_{i} = [ var . - ( \frac{\vert {D}_{i} - {E}_{i} \vert}{S} ) ] \times Max ( {D}_{i} , {E}_{i} ) \qquad ( 1 )$$

wherein
var.=0.8˜1.2,
Dᵢ, Eᵢ: any two basic-color sub-pixel data,
S: the maximal grey level.

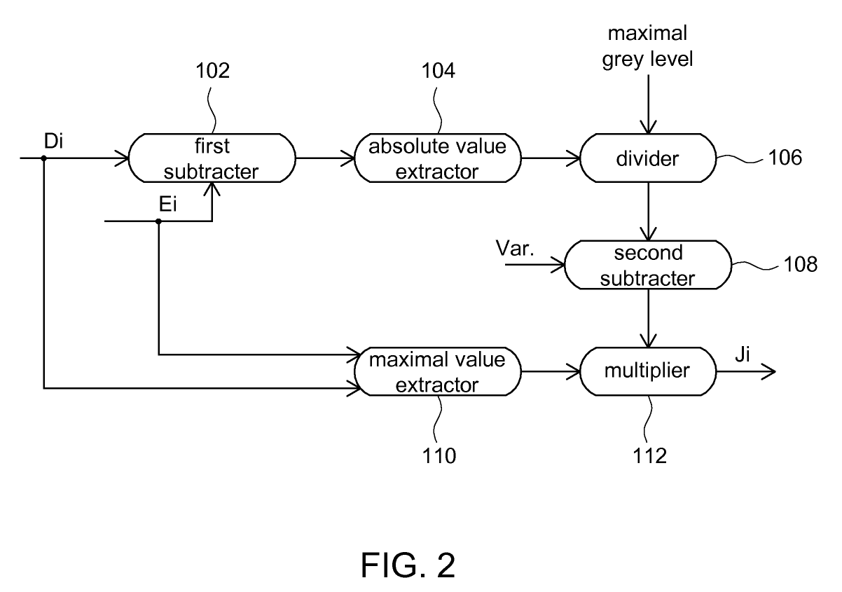

Referring to FIG. 2, a block diagram of an image data conversion device according to a first embodiment of the invention is shown. The image data conversion device comprises a first subtractor 102 used for receiving any two basic-color sub-pixel data Dᵢ and Eᵢ of the original image data and calculating the difference between the two selected sub-pixel data. The absolute value extractor 104 is used for receiving the difference and taking a absolute value of the difference. The divider 106 is used for receiving the absolute value and dividing it by the maximal grey level to obtain a quotient. The second subtractor 108 is used for calculating a difference between the variable (Var.) and the quotient, and the difference is regarded as a parameter, wherein the variable ranges between 0.8˜1.2. The maximal value extractor 110 is used for taking the maximal of the two basis-color sub-pixel data Dᵢ and Eᵢ. The multiplier 112 is used for multiplying the maximal of two basic-color sub-pixel data by the parameter and using the product as the color-enhancing sub-pixel data Jᵢ. The color-enhancing sub-pixel data Jᵢ is then obtained by inputting the original image data Dᵢ and Eᵢ to the calculation as indicated in FIG. 2.

When the three basic-color sub-pixels are the red sub-pixel, the green sub-pixel, and the blue sub-pixel, the color of the color-enhancing sub-pixel is preferably a mixed color of any two of the three basic colors namely red (R), green (G), and blue (B). For example, the color of the color-enhancing sub-pixel can be yellow (Y), a color obtained by mixing red (R) and green (G), and the yellow sub-pixel data Yᵢ is represented as:

$${Y}_{i} = [ var . - ( \frac{\vert {R}_{i} - {G}_{i} \vert}{S} ) ] \times Max ( {R}_{i} , {G}_{i} )$$

wherein
var.=0.8˜1.2,
Rᵢ and Gᵢ: the red sub-pixel data and the green sub-pixel data,
S: the maximal grey level.

For example, when the variable var.=1.0, the maximal grey level S is 255, and the image data (R₁, G₁, B₁)=(150, 100, 50), then Y₁={1.0−[(150−100)/255]}×Max(150, 100)=120 according to the calculation formulas of the yellow sub-pixel data of the present embodiment of the invention. Conventionally, the minimal value of the red sub-pixel data and the green sub-pixel data is used as the yellow sub-pixel data Y₁′=Min(150, 100)=100. On the part of the same item of image data, the larger the value of the yellow sub-pixel data of the present embodiment of the invention is, the larger the color saturation will be, hence providing a better expansion effect of the color gamut.

Besides, when the variable var.=1.0 and the image data (R₂, G₂, B₂)=(255, 0, 0) is a pure color, then Y₂={1.0−[(255−0)/255]}×Max(255, 0)=0 according to the calculation formulas of the yellow sub-pixel data of the present embodiment of the invention. Thus, the original image data of pure red is still pure red after the original image data is converted into a four-color image data (R₂′, G₂′, B₂′, Y₂)=(255, 0, 0, 0). To summarize, the image data conversion method of the present embodiment of the invention expands color gamut and meanwhile maintains pure-color display effect.

Despite the image data conversion method of the present embodiment of the invention is exemplified by a yellow sub-pixel data, the image data conversion method of the invention and the device thereof is not limited thereto. For example, the color of the color-enhancing sub-pixel can be cyan (C), a color obtained by mixing green (G) and blue (B), and the data of the color-enhancing sub-pixel is obtained from a green sub-pixel data Gᵢ and a blue sub-pixel data Bᵢ via similar calculation. The color of the color-enhancing sub-pixel can also be magenta (M), a color obtained by mixing red (R) and blue (B), and the data of the color-enhancing sub-pixel is obtained from a red sub-pixel data Rᵢ and a blue sub-pixel data Bᵢ via similar calculation.

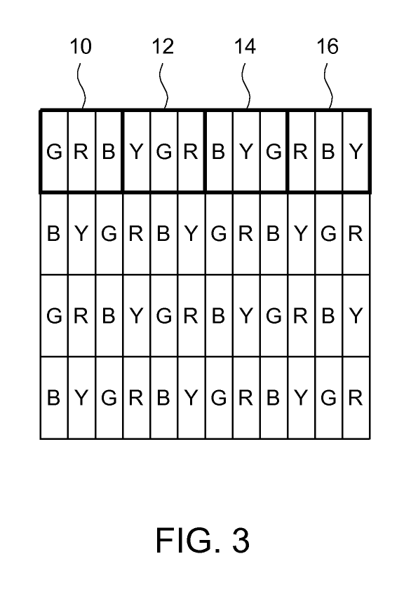

The image data processing method of the present embodiment of the invention needs to go with a specific display pixel array formed by the three basic-color sub-pixels D, E and F and one color-enhancing sub-pixel J, wherein a selected pixel is formed by any three of the four sub-pixels. Referring to FIG. 3, a perspective of a display pixel array according to a first embodiment of the invention is shown. The display pixel array of the present embodiment of the invention comprises a plurality of pixels arranged in a matrix. Each row of pixels is formed by the repetition of the unit formed by three basic-color sub-pixels, namely red sub-pixel, green sub-pixel and blue sub-pixel, and a color-enhancing sub-pixel yellow sub-pixel. The sub-pixels of the same color disposed in two neighboring rows are alternated by two sub-pixels. A selected pixel is formed by any three of the four sub-pixels, namely red sub-pixel, green sub-pixel, blue and yellow sub-pixel. For example, the selected pixel 10, 12, 14 and 16 respectively are GRB, YGR, BYG and RBY as indicated in FIG. 3. As each selected pixel lacks a sub-pixel color, a selected pixel needs to be compensated by a neighboring selected pixel so as to completely display an item of pixel data. How a selected pixel and its neighboring selected pixel achieve color compensation via the sharing of sub-pixel data is disclosed below.

As the converted image data (Dᵢ, Eᵢ, Fᵢ, Jᵢ) comprises three basic-color sub-pixel data Dᵢ, Eᵢ and Fᵢ and a color-enhancing sub-pixel data Jᵢ. The converted four-color image data comprises a first value Dᵢ, Eᵢ, Fᵢ belonging to the sub-pixel color of the selected pixel (i.e. DEF) and a second value Jᵢ not belonging to the sub-pixel color of the selected pixel. Meanwhile, the selected pixel and its neighboring selected pixel apply specific weighting calculation to the sub-pixel data and use the weighted sub-pixel data as the actually outputted sub-pixel data. In greater details, firstly, at least one neighboring selected pixel inputs a third value D_{i±1}, E_{i±1} or F_{i±1} is belonging to the sub-pixel color of the selected pixel. Next, when the sub-pixel color corresponding to the third value is identical to the sub-pixel color corresponding to the first value, the minimal value of the first value and the third value is used as the data value of the sub-pixel color outputted from the selected pixel. Then, the first value is used as the data value of the remaining sub-pixel color outputted from the selected pixel. Preferably, the neighboring selected pixel is situated next to the selected pixel in the first dimension, that is, the horizontal direction, not only maintaining the original color combination but also eliminating vertical deckles when displaying a partial picture.

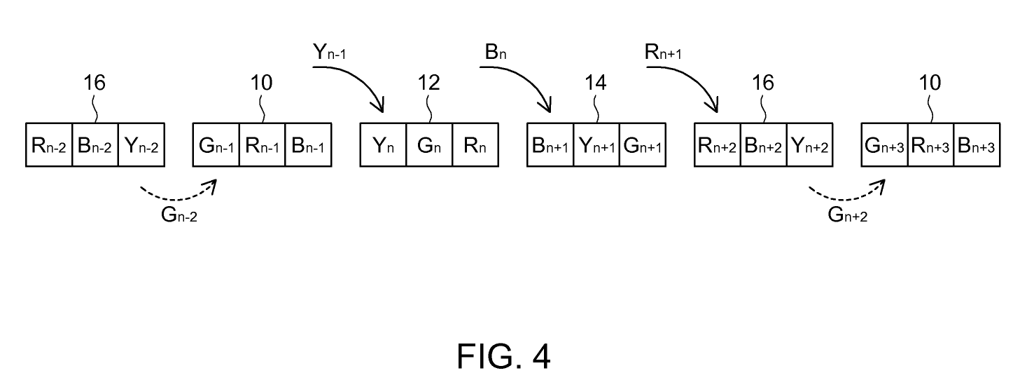

A data sharing method for a selected pixel and its neighboring pixel unit is exemplified below with accompanying drawings and elaboration. Each selected pixel is capable of sharing data with at least one of the neighboring pixel units positioned at the right, the left, the top or the bottom of the selected pixel, and is not limited to the elaboration and drawings used in the exemplification below. FIG. 4 shows a perspective of pixel data sharing according to a first embodiment of the invention. The display pixel array comprises four selected pixels 10, 12, 14 and 16. The sub-pixel colors respectively are GRB, YGR, BYG and RBY, which are sequentially arranged along the first dimension. Each item of the converted pixel data has four items of sub-pixel data. For example, the pixel data of the selected pixel YGR 12 is (Rₙ, Gₙ, Bₙ, Yₙ), which comprises a first value Yₙ, Gₙ, Rₙ belonging to the sub-pixel color YGR of the selected pixel 12 and a second value Bₙ not belonging to the sub-pixel color YGR of the selected pixel 12. The converted pixel data (Rₙ₋₁, Gₙ₋₁, Bₙ₋₁, Yₙ₋₁) of the left neighboring selected pixel GRB 10 in the same row comprises a first value Rₙ₋₁, Gₙ₋₁, Bₙ₋₁ belonging to the sub-pixel color GRB of the selected pixel 10 and a second value Yₙ₋₁ not belonging to the sub-pixel color GRB of the selected pixel 10. Referring to FIG. 4, the selected pixel 12 receives a third value Yₙ₋₁ inputted from the left neighboring selected pixel 10, wherein the third value Yₙ₋₁ does not belong to the sub-pixel color GRB of the neighboring selected pixel 10 but belongs to the sub-pixel color YGR of the selected pixel 12. Next, when the sub-pixel color corresponding to the third value Yₙ₋₁ is identical to the sub-pixel color corresponding to the first value Yₙ, Gₙ, Rₙ, the minimal value of the first value Yₙ and the third value Yₙ₋₁ is used as the data value Y′ₙ=Min(Yₙ₋₁, Yₙ) of the sub-pixel color outputted from the selected pixel, and the remaining first values Gₙ and Rₙ are used as the data values of the remaining sub-pixel color GR outputted from the selected pixel 12. Thus, the sub-pixel data (Yₙ′, Gₙ, Rₙ) of the selected pixel 12 uses [Min(Yₙ₋₁, Yₙ), Gₙ, Rₙ] as the actually outputted value.

According to the same data sharing method, the first value of the selected pixel BYG 14 is Bₙ₊₁, Yₙ₊₁, Gₙ₊₁, and the third value inputted from the left neighboring selected pixel 12 and received by the selected pixel BYG 14 is Bₙ, wherein the third value does not belong to the sub-pixel color YGR of the neighboring selected pixel 12 but belongs to the sub-pixel color BYG of the selected pixel 14. Next, the minimal value of the first value Bₙ₊₁ and the third value Bₙ is used as the data value B′ₙ₊₁=Min(Bₙ, Bₙ₊₁) of the sub-pixel color outputted from the selected pixel. Thus, the sub-pixel data of the selected pixel 14 uses [Min(Bₙ, Bₙ₊₁), Yₙ₊₁, Gₙ₊₁] as the actually outputted value.

Likewise, the first value of the selected pixel RBY 16 is Rₙ₊₂, Bₙ₊₂, Yₙ₊₂, and the third value inputted from the left neighboring selected pixel 14 and received by the selected pixel RBY 16 is Rₙ₊₁, wherein the third value does not belong to the sub-pixel color BYG of the neighboring selected pixel 14 but belongs to the sub-pixel color RBY of the selected pixel 16. Next, the minimal value of the first value Rₙ₊₂ and the third value Rₙ₊₁ is used as the data value R′ₙ₊₂=Min(Rₙ₊₁, Rₙ₊₂) of the sub-pixel color outputted from the selected pixel 16. Thus, the sub-pixel data of the selected pixel 16 uses [Min(Rₙ₊₁, Rₙ₊₂), Bₙ₊₂, Yₙ₊₂] as the actually outputted value. As the display pixel array of the present embodiment of the invention is formed by the repetitive arrangement of the four selected pixels 10, 12, 14 and 16, the same data sharing method can also be applied to the entire display.

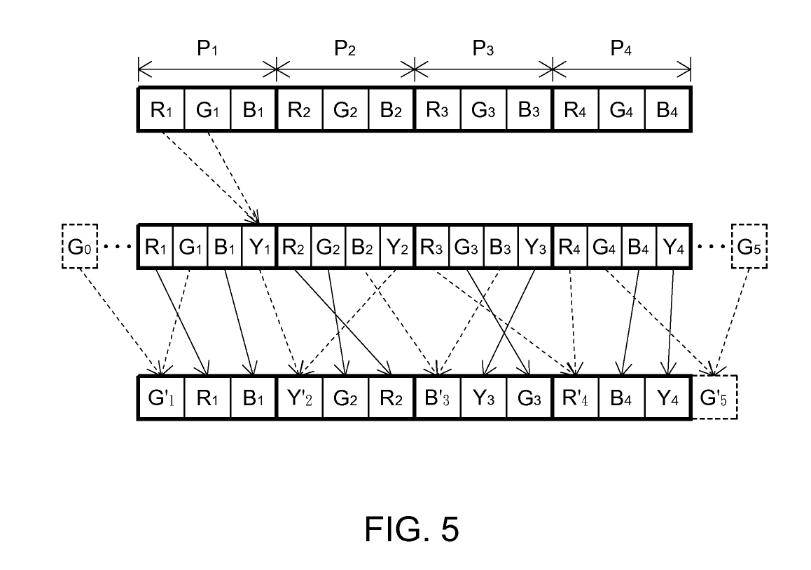

A practical example of an image processing method is illustrated below. Referring to FIG. 5, a perspective of an image processing method according to a first embodiment of the invention is shown. Each item of pixel data comprises the sub-pixel data of three primal colors, wherein the pixel P₁ comprises a sub-pixel data (R₁, G₁, B₁), the pixel P₂ comprises a sub-pixel data (R₂, G₂, B₂), the pixel P₃ comprises a sub-pixel data (R₃, G₃, B₃), and the pixel P₄ comprises a sub-pixel data (R₄, G₄, B₄). Then, the yellow sub-pixel data is calculated according to the formulas Yi={1.0−[(Rᵢ−Gᵢ)/255]}×Max(Rᵢ, Gᵢ). After data conversion, the pixel P₁ comprises a sub-pixel data (R₁, G₁, B₁, Y₁), the pixel P₂ comprises a sub-pixel data (R₂, G₂, B₂, Y₂), the pixel P₃ comprises a sub-pixel data (R₃, G₃, B₃, Y₃), and the pixel P₄ comprises a sub-pixel data (R₄, G₄, B₄, Y₄), wherein the pixel data is stored in the register first.

A part of the converted sub-pixel data is directly used as the actually outputted sub-pixel data value, but another part of the converted sub-pixel data will be shared with the neighboring pixels first, and then the shared value is used as the actually outputted sub-pixel data value. On the part of the pixel P₁, the pixel P₁ comprises a green sub-pixel (G), a red sub-pixel (R) and a blue sub-pixel (B), wherein the actually outputted green sub-pixel value G₁′ is the minimal value of G₀ and G₁ of the register, and the actually outputted red sub-pixel data value R₁ and blue sub-pixel data value B₁ are R₁ and B₁ directly obtained from the register. Lastly, the actually outputted sub-pixel data value of the pixel P₁ is [G₁′=min(G₀, G₁), R₁, B₁], wherein the yellow sub-pixel that is absent in the pixel P₁ is expressed by a neighboring pixel P₂ through data sharing.

On the part of the pixel P₂, the pixel P₂ comprises a yellow sub-pixel (Y), a green sub-pixel (G) and a red sub-pixel (R), wherein the actually outputted yellow sub-pixel value Y₂′ is the minimal value of Y₁ and Y₂ of the register and the actually outputted green sub-pixel data value G₂ and red sub-pixel data value R₂ are G₂ and R₂ directly obtained from the register. Lastly, the actually outputted sub-pixel data value of the pixel P₂ is [Y₂′=min(Y₁, Y₂), G₂, R₂], wherein the blue sub-pixel that is absent in the pixel P₂ is expressed by a neighboring pixel P₃ through data sharing. It is noted that the pixel P₂ neighbors the pixel P₁ by a yellow sub-pixel which is absent in the pixel P₁, and the value of the yellow sub-pixel is obtained by sharing the yellow sub-pixel data of the pixel P₁ and the pixel P₂. Therefore, the pixel P₁ virtually displayed with four different colors is displayed according to four consecutive sub-pixel data (G₁′, R₁, B₁, Y₂′) so that the display effect is improved.

On the part of the pixel P₃, the pixel P₃ comprises a blue sub-pixel (B), yellow sub-pixel (Y) and green sub-pixel (G), the actually outputted blue sub-pixel value B₃′ is the minimal value of B₂ and B₃ of the register, and the actually outputted yellow sub-pixel data value Y₃ and green sub-pixel data value G₃ are Y₃ and G₃ directly obtained from the register. Lastly, the actually outputted sub-pixel data value of the pixel P₃ is [B₃′=min(B₂, B₃), Y₃, G₃], wherein the red sub-pixel absent in the pixel P₃ is expressed by a neighboring pixel P₄ through data sharing. It is noted that the pixel P₃ neighbors the pixel P₂ by a blue sub-pixel which is absent in the pixel P₂, and the value of the yellow sub-pixel is obtained by sharing the blue sub-pixel data of the pixel P₂ and the pixel P₃. Therefore, the pixel P₂, virtually displayed with four different colors is displayed according to four consecutive sub-pixel data (Y₂′, G₂, R₂, B₃′) so that the display effect is improved.

On the part of the pixel P₄, the pixel P₄ comprises a red sub-pixel, a blue sub-pixel and a yellow sub-pixel, the actually outputted red sub-pixel value R₄′ is the minimal value of R₃ and R₄ of the register, the actually outputted blue sub-pixel data value B₄ and the yellow sub-pixel data value Y₄ are B₄, Y₄ directly taken from the register. Lastly, the actually outputted sub-pixel data value of the pixel P₄ is [R₄′=min(R₃, R₄), B₄, Y₄], wherein the green sub-pixel absent in the pixel P₄ is expressed by the right neighboring pixel (not illustrated) through data sharing. It is noted that the pixel P₄ neighbors the pixel P₃ by a red sub-pixel which is absent in the pixel P₃, and the value of the red sub-pixel is obtained by sharing the red sub-pixel data of the pixel P₄ and the pixel P₃. Therefore, the pixel P₃ is displayed according to four consecutive sub-pixel data (B₃′, Y₃, G₃, R₄′). Likewise, the pixel to the right of the pixel P₄ neighbors the pixel P₄ by a green sub-pixel which is absent in the pixel P₄, and the value of the green sub-pixel is obtained by sharing the green sub-pixel data. Thus, the pixel P₄ is displayed according to four consecutive sub-pixel data (R₄′, B₄, Y₄, G₅′).

Conventionally, the average value of the sub-pixel data shared by two neighboring pixels is used as the actually outputted value. However, edge blur will occur when processing the borders or texts which have strong contrast with neighboring pixels. Compared with the conventional image processing method, the sub-pixel data of the present embodiment of the invention is shared by taking the minimal value of the sub-pixel data as the actually outputted value, so that color contrast still exists when processing the image where neighboring pixels have strong contrast. Thus, the contrast and sharpness of image are maintained and the original image is truthfully displayed.

To summarize, according to the image data conversion and processing method of the present embodiment of the invention, a three-color data is converted into a four-color data, the actually outputted sub-pixel data is determined according to a specific sub-pixel data sharing method. The color-enhancing sub-pixel data obtained according to the calculation formulas of the invention not only expands color gamut but also maintains pure-color display effect. Besides, the contrast and sharpness of image are maintained according to the specific sub-pixel data sharing.

### Second Embodiment

The present embodiment of the invention differs with the above embodiment in that the original image data is converted into a five-color data and the accompanying display pixel array is also different. However the spirit of the sub-pixel data sharing is still the same. The similarities are not repeated here, and only the differences are elaborated below.

The image data conversion method of the present embodiment of the invention converts a three-color data into a five-color data. In addition to three items of basic-color sub-pixel data Dᵢ, Eᵢ, Fᵢ, there are another two items of color-enhancing sub-pixel data Jᵢ, Kᵢ. The calculation formulas (1) for the first color-enhancing sub-pixel data Jᵢ is the same as in the first embodiment. The second color-enhancing sub-pixel data Kᵢ is obtained from the minimal value of the three basic-color sub-pixel data Dᵢ, Eᵢ, Fᵢ. The second color of the color-enhancing sub-pixel is preferably white for increasing display luminance, and the calculation formulas (2) is represented as:

Kᵢ=Min(Dᵢ,Eᵢ,Fᵢ) (2)

Next, the three basic-color sub-pixel data are adjusted according to the second color-enhancing sub-pixel data Kᵢ, and the values Dᵢ′, Eᵢ′, Fᵢ′ of the adjusted three basic-color sub-pixel data are:

$${D}_{i}^{′} = {D}_{i} \times m - {K}_{i}$$

$${E}_{i}^{′} = {E}_{i} \times m - {K}_{i}$$

$${F}_{i}^{′} = {F}_{i} \times m - {K}_{i} , \\ wherein m = 1 + \frac{Max ( {D}_{i} , {E}_{i} , {F}_{i} )}{Min ( {D}_{i} , {E}_{i} , {F}_{i} )} ;$$

For example, the three basic-color sub-pixels and the two color-enhancing sub-pixel respectively are red sub-pixel, green sub-pixel, blue sub-pixel, yellow sub-pixel, and white sub-pixel, the data value of the original image data (Roᵢ, Goᵢ, Boᵢ) after image data conversion is:

$${Y}_{i} = [ var . - ( \frac{\vert {Ro}_{i} - {Go}_{i} \vert}{s} ) ] \times Max ( {Ro}_{i} , {Go}_{i} ) , \\ wherein var . = 0.8 \sim 1.2$$

$$S \text{:} the maximal grey level$$

$${W}_{i} = Min ( {Ro}_{i} , {Go}_{i} , {Bo}_{i} )$$

$${R}_{i} = {Ro}_{i} \times m - {W}_{i}$$

$${G}_{i} = {Go}_{i} \times m - {W}_{i}$$

$${B}_{i} = {Bo}_{i} \times m - {W}_{i} , \\ wherein m = 1 + \frac{Max ( {Ro}_{i} , {Go}_{i} , {Bo}_{i} )}{Min ( {Ro}_{i} , {Go}_{i} , {Bo}_{i} )} .$$

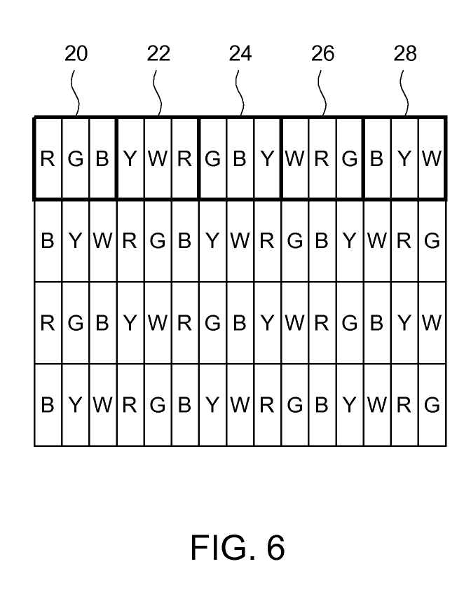

On the other hand, the display pixel array of the present embodiment of the invention comprises a plurality of pixels arranged in a matrix. Each row of pixels is formed by the repetition of the unit formed by three basic-color sub-pixels X, Y and Z and two color-enhancing sub-pixels J and K. The sub-pixels of the same color disposed in two neighboring rows are alternated by two or three sub-pixels. Any three of the five sub-pixels constitute a selected pixel. Referring to FIG. 6, a display pixel array according to a second embodiment of the invention is shown. For example, the display pixel array of the present embodiment of the invention comprises a plurality of pixels arranged in a matrix, wherein each row of pixels is formed by the repetition of the unit formed by three basic-color sub-pixels, namely red sub-pixel (R), green sub-pixel (G) and blue sub-pixel (B) and two color-enhancing sub-pixels namely yellow sub-pixel (Y) and white sub-pixel (W). The sub-pixels of the same color disposed in two neighboring rows are alternated by two sub-pixels, and a selected pixel is formed by any three of the five sub-pixels namely red sub-pixel (R), green sub-pixel (G), blue sub-pixel (B), yellow sub-pixel (Y) and white sub-pixel (W). For example, the selected pixel 20, 22, 24, 26 and 28 respectively are RGB, YWR, GBY, WRG and BYW sequentially arranged in repetition along the first dimension.

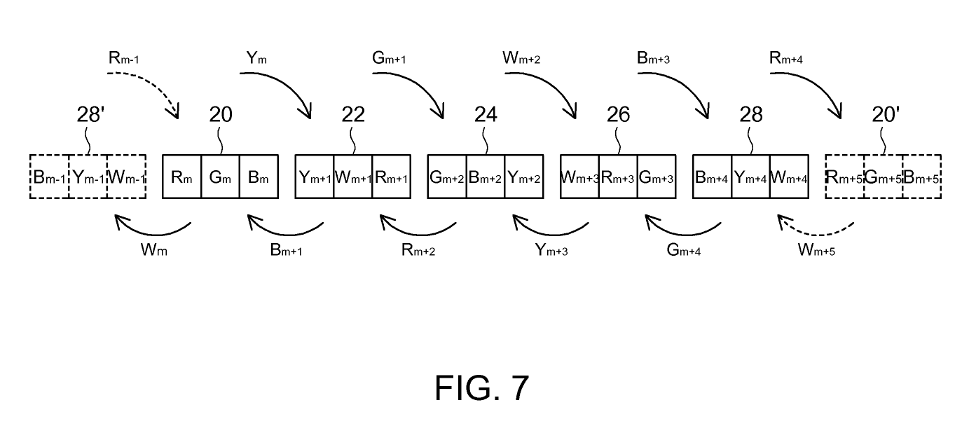

FIG. 7 shows a perspective of pixel data sharing according to a second embodiment of the invention. The pixel data (Rₘ, Gₘ, Bₘ, Yₘ, Wₘ) of the selected pixel RGB 20 comprises a first value Rₘ, Gₘ, Bₘ belonging to the ROB sub-pixel color of the selected pixel 20 and a second value Yₘ, Wₘ not belonging to the RGB sub-pixel color of the selected pixel 20, wherein the second value Yₘ, Wₘ will respectively be transmitted to the left neighboring pixel unit 28′ and the right neighboring pixel unit 22. On the part of the second value Rₘ₋₁, Gₘ₋₁ of the pixel data (Rₘ₋₁, Gₘ₋₁, Bₘ₋₁, Yₘ₋₁, Wₘ₋₁) of the selected pixel BYW 28′ not belonging to the sub-pixel color BYW, Rₘ₋₁ will be transmitted to and shared with the sub-pixel data having the same color and disposed in the neighboring pixel unit 20. The pixel data (Rₘ₊₁, Gₘ₊₁, Bₘ₊₁, Yₘ₊₁, Wₘ₊₁) of the selected pixel YWR 22 comprises a first value Yₘ₊₁, Wₘ₊₁, Rₘ₊₁ belonging to the YWR sub-pixel color of the selected pixel 22 and a second value Bₘ₊₁, Gₘ₊₁, not belonging to the YWR sub-pixel color of the selected pixel 22. The second value Bₘ₊₁, Gₘ₊₁, will be respectively transmitted to the left neighboring pixel unit 20 and the right neighboring pixel unit 24. Referring to FIG. 7, the selected pixel RGB 20 receives a third value Rₘ₋₁ inputted from the left neighboring selected pixel 28′, wherein the third value Rₘ₋₁ does not belong to the sub-pixel color BYW of the neighboring selected pixel 28′ but belongs to the RGB sub-pixel color of the selected pixel 20. At the same time, the selected pixel RGB 20 receives a third value Bₘ₊₁ inputted from the right neighboring selected pixel 22, wherein the third value Bₘ₊₁ does not belong to the YWR sub-pixel color of the neighboring selected pixel 22 but belongs to the RGB sub-pixel color of the selected pixel 20. Next, when the sub-pixel color corresponding to the third values Rₘ₋₁ and Bₘ₊₁ is identical to the sub-pixel color corresponding to the first values Rₘ, Gₘ and Bₘ, the minimal value of the first value Rₘ, Bₘ and the third value Rₘ₋₁, Bₘ₊₁ is used as the data value R′ₘ=Min(Rₘ₋₁, Rₘ), B′ₘ=Min(Bₘ, Bₘ₊₁) of the sub-pixel color outputted from the selected pixel. Then, the remaining first value Gₘ is directly used as the data value of the remaining green sub-pixel outputted from the selected pixel 20. Thus, the sub-pixel data (Rₘ′, Gₘ, Bₘ′) of the selected pixel RGB 20 uses [Min(Rₘ₋₁, Rₘ), Gₘ, Min(Bₘ, Bₘ₊₁)] as the actually outputted value.

On the part of the selected pixel YWR 22, the first value is Yₘ₊₁, Wₘ₊₁, Rₘ₊₁. The selected pixel YWR 22 receives a third value Yₘ inputted from the left neighboring selected pixel RGB 20, wherein the third value Yₘ does not belong to the RGB sub-pixel color of the neighboring selected pixel 20 but belongs to the YWR sub-pixel color of the selected pixel 22. At the same time, the selected pixel YWR 22 receives a third value Rₘ₊₂ inputted from the right neighboring selected pixel GBY 24, wherein the third value Rₘ₊₂ does not belong to the GBY sub-pixel color of the neighboring selected pixel 24 but belongs to the YWR sub-pixel color of the selected pixel 22. Next, when the sub-pixel color corresponding to the third values Yₘ and Rₘ₊₂ is identical to the sub-pixel color corresponding to the first value Yₘ₊₁, Wₘ₊₁, Rₘ₊₁, the minimal value of the first value Yₘ₊₁, Rₘ₊₁ and the third value Yₘ, Wₘ, Rₘ₊₂ of the selected pixel 22 is used as the data value of the sub-pixel color outputted from the selected pixel YWR 22, and the remaining first value Wₘ₊₁ is directly used as the data value of the remaining white sub-pixel outputted from the selected pixel 22. Thus, the sub-pixel data of the selected pixel YWR 22 uses [Min(Yₘ, Yₘ₊₁), Wₘ₊₁, Min(Rₘ₊₁, Rₘ₊₂)] as the actually outputted value.

On the part of the selected pixel GBY 24, the first value is Gₘ₊₂, Bₘ₊₂, Yₘ₊₂. The selected pixel GBY 24 receives a third value Gₘ₊₁ inputted from the left neighboring selected pixel YWR 22, wherein the third value Gₘ₊₁ does not belong to the YWR sub-pixel color of the selected pixel 22 but belongs to the GBY sub-pixel color of the selected pixel 24. At the same time, the selected pixel GBY 24 receives a third value Yₘ₊₃ inputted from the right neighboring selected pixel WRG 26, wherein the third value Yₘ₊₃ does not belong to the WRG sub-pixel color of the selected pixel 26 but belongs to the GBY sub-pixel color of the selected pixel 24. When the sub-pixel color corresponding to the third value Gₘ₊₁, Yₘ₊₃ is identical to the sub-pixel color corresponding to the first value Gₘ₊₂, Bₘ₊₂, Yₘ₊₂, the minimal value of the first value Gₘ₊₂, Yₘ₊₂ and the third value Gₘ₊₁, Yₘ₊₃ of the selected pixel 24 is used as the data value of the sub-pixel color outputted from the selected pixel 24, the remaining first value Bₘ₊₂ is directly used as the data value of the remaining blue sub-pixel outputted from the selected pixel 24. Thus, the sub-pixel data of the selected pixel GBY 24 uses [Min(Gₘ₊₁, Gₘ₊₂), Bₘ₊₂, Min(Yₘ₊₂, Yₘ₊₃)] as the actually outputted value.

On the part of the selected pixel WRG 26, the first value is Wₘ₊₃, Rₘ₊₃, Gₘ₊₃. The selected pixel WRG 26 receives a third value Wₘ₊₂ outputted from the left neighboring selected pixel GBY 24 and at the same time receives a third value Gₘ₊₄ outputted from the right neighboring selected pixel BYW 28. When the sub-pixel color corresponding to the third value is identical to the sub-pixel color corresponding to the first value, the minimal value of the first value Wₘ₊₃, Gₘ₊₃ and the third value Wₘ₊₂, Gₘ₊₄ of the selected pixel 26 is used as the data value of the sub-pixel color outputted from the selected pixel WRG 26, and the remaining first value Rₘ₊₃ is directly used as the data value of the sub-pixel color R outputted from the selected pixel 26. Thus, the sub-pixel data of the selected pixel WRG 26 uses [Min(Wₘ₊₂, Wₘ₊₃), Rₘ₊₃, Min(Gₘ₊₃, Gₘ₊₄),] as the actually outputted value.

On the part of the selected pixel BYW 28, the first value is Bₘ₊₄, Yₘ₊₄, Wₘ₊₄. The selected pixel BYW 28 receives a third value Bₘ₊₃ outputted from the left neighboring selected pixel WRG 26 and at the same time receives a third value Wₘ₊₅ outputted from the right neighboring selected pixel RGB 20′. When the sub-pixel color corresponding to the third value is identical to the sub-pixel color corresponding to the first value, the minimal value of the first value Bₘ₊₄, Wₘ₊₄ and the third value Bₘ₊₃, Wₘ₊₅ of the selected pixel BYW 28 is used as the data value of the sub-pixel color outputted from the selected pixel BYW 28, and the remaining first value Yₘ₊₄ is used as the data value of the sub-pixel of remaining color outputted from the selected pixel BYW 28. Thus, the sub-pixel data of the selected pixel BYW 28 uses [Min(Bₘ₊₃, Bₘ₊₄), Yₘ₊₄, Min(Wₘ₊₄, Wₘ₊₅)] as the actually outputted value.

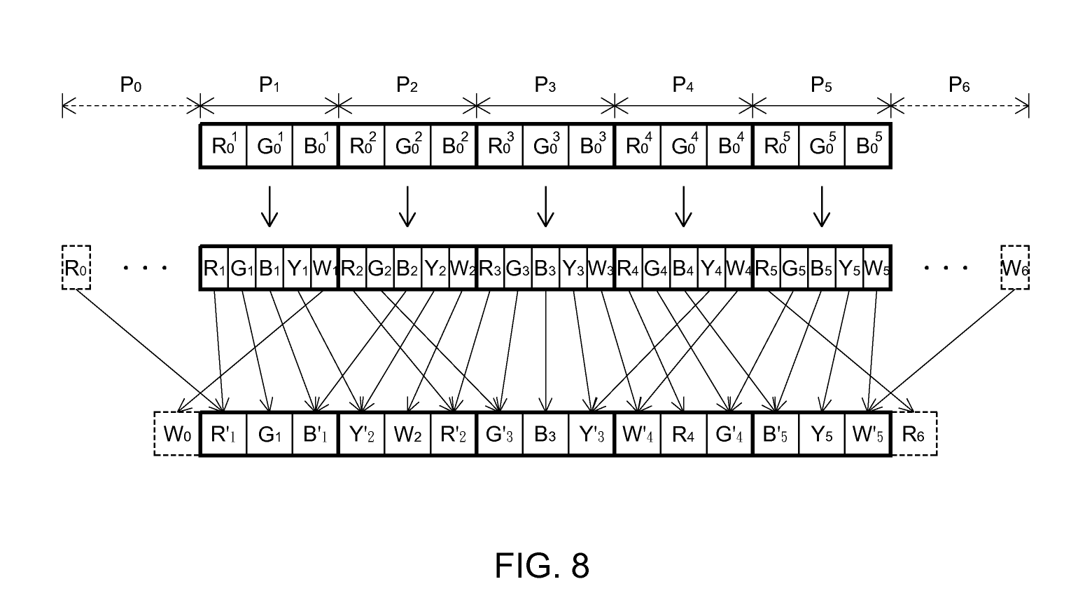

A practical example of an image processing method is illustrated below. Referring to FIG. 8, a perspective of an image processing method according to a second embodiment of the invention is shown. After the pixel data (Rₒ, Gₒ, Bₒ) executes data conversion according to the above formula, the pixel P₁ comprises a sub-pixel data (R₁, G₁, B₁, Y₁, W₁), the pixel P₂ comprises a sub-pixel data (R₂, G₂, B₂, Y₂, W₂), the pixel P₃ comprises a sub-pixel data (R₃, G₃, B₃, Y₃, W₃), the pixel P₄ comprises a sub-pixel data (R₄, G₄, B₄, Y₄, W₄), and the pixel P₅ comprises a sub-pixel data (R₅, G₅, B₅, Y₅, W₅), wherein the pixel data is stored of the register first.

A part of the converted sub-pixel data is directly used as the actually outputted sub-pixel data value, but another part of the converted sub-pixel data will be shared with the neighboring pixels first, and then the shared value is used as the actually outputted sub-pixel data value. On the part of the pixel P₁, the pixel P₁ comprises a red sub-pixel (R), a green sub-pixel (G) and a blue sub-pixel (B), wherein the actually outputted green sub-pixel data value G₁ is directly obtained from the register, the actually outputted red sub-pixel value R₁′ is the minimal value of R₁ and R₀ of the register, and the actually outputted blue sub-pixel value B₁′ is the minimal value of B₁ and B₂ of the register. Lastly, the actually outputted sub-pixel data values of the pixel P₁ are [R₁′=min(R₀, R₁), G₁, B₁′=min(B₁, B₂)], wherein the yellow sub-pixel and the white sub-pixel that are absent in the pixel P₁ are expressed by its neighboring pixels P₂ and P₀ through data sharing.

On the part of the pixel P₂, the pixel P₂ comprises a yellow sub-pixel (Y), a white sub-pixel (W) and a red sub-pixel (R), wherein the actually outputted yellow sub-pixel value Y₂′ is the minimal value of Y₁ and Y₂ of the register, the actually outputted white sub-pixel value W₂′ is W₂ of the register, the actually outputted red sub-pixel value R₂′ is the minimal value of R₂ and R₃ of the register. Lastly, the actually outputted sub-pixel data value of the pixel P₂ is [Y₂′=min(Y₁, Y₂), W₂, R₂′=min(R₂, R₃)], wherein the blue sub-pixel data of the pixel P₂ is expressed as B₁′=min(B₁, B₂) by sharing the data of the blue sub-pixel data of the pixel P₁, and the green sub-pixel that is absent in the pixel P₂ is expressed by the pixel P₃ through data sharing.

On the part of the pixel P₃, the pixel P₃ comprises a green sub-pixel (G), a blue sub-pixel (B) and a yellow sub-pixel (Y), wherein the actually outputted green sub-pixel value G₃′ is the minimal value of G₂ and G₃ of the register, the actually outputted blue sub-pixel data value directly uses B₃ of the register, the actually outputted yellow sub-pixel value Y₃′ is the minimal value of Y₃ and Y₄ of the register. Lastly, the actually outputted sub-pixel data value of the pixel P₃ is [G₃′=min(G₂, G₃), B₃, Y₃′=min(Y₃, Y₄)], wherein the red of the pixel P₃ is expressed as R₂′=min(R₂, R₃) by sharing the data of the red sub-pixel of the pixel P₂, and the white sub-pixel that is absent in the pixel P₃ is expressed by the pixel P₄ through data sharing.

On the part of the pixel P₄, the pixel P₄ comprises a white sub-pixel (W), a red sub-pixel (R) and a green sub-pixel (G), wherein the actually outputted white sub-pixel value W₄′ is the minimal value of W₃ and W₄ of the register, the actually outputted red sub-pixel value is directly R₄ of the register, and the actually outputted green sub-pixel value G₄′ is the minimal value of G₄ and G₅ of the register. Lastly, the actually outputted sub-pixel data value of the pixel P₄ is [W₄′=min(W₃, W₄), R₄, G₄′=min(G₄, G₅)], wherein the yellow sub-pixel of the pixel P₄ is expressed as Y₃′=min(Y₃, Y₄) by sharing the data of the yellow sub-pixel data of the pixel P₃, and the blue sub-pixel that is absent in the pixel P₄ is expressed by the pixel P₅ through data sharing.

On the part of the pixel P₅, the pixel P₅ comprises a blue sub-pixel (B), a yellow sub-pixel (Y) and a white sub-pixel (W), wherein the actually outputted blue sub-pixel value B₅′ is the minimal value of B₄ and B₅ of the register, the actually outputted the yellow sub-pixel data value Y₅ is directly Y₅ of the register, and the actually outputted white sub-pixel value W₅′ is the minimal value of W₅ and W₆ of the register. Lastly, the actually outputted sub-pixel data value of the pixel P₅ is [B₅′=min(B₄, B₅), Y₅, W₅′=min(W₅, W₆)], wherein the green sub-pixel of the pixel P₅ is expressed as G₄′=min(G₄, G₅) by sharing the data of the green sub-pixel of the pixel P₄, and the red sub-pixel that is absent in the pixel P₅ is expressed by the pixel P₆ through data sharing. Thus, the pixel data P₅ is virtually expressed by five consecutive sub-pixel data (G₄′, B₅′, Y₅, W₅′, R₆′) having five different colors. Likewise, the pixel data P₁ is virtually expressed by five sub-pixel data (W₀′, R₁′, G₁, B₅′, Y₂′) having five different colors, the pixel data P₂ is virtually expressed by five sub-pixel data (B₁′, Y₂′, W₂, R₂′, G₃′), the pixel data P₃ is virtually expressed by five consecutive sub-pixel data (R₂′, G₃′, B₃, Y₃′, W₄′), and the pixel data P₄ is virtually expressed by five consecutive sub-pixel data (Y₃′, W₄′, R₄, G₄′, B₅′). That is, each item of pixel data is expressed by its own three sub-pixels and two immediately neighboring sub-pixels, wherein the sub-pixels have five colors in total. Under the original circuit structure of the display panel, each item of pixel data is expressed by five colors, and both the color and the brightness are enhanced.

### Third Embodiment

The present embodiment of the invention differs with the above embodiment in the way of sharing the sub-pixel data after the original image data is converted into a five-color data. The similarities are not repeated here, and only the differences are elaborated below. According to the data sharing of the present embodiment of the invention, every five pixels form a sharing unit, and data is shared between the sub-pixels of the five pixels, and there is no sharing between the sharing units.

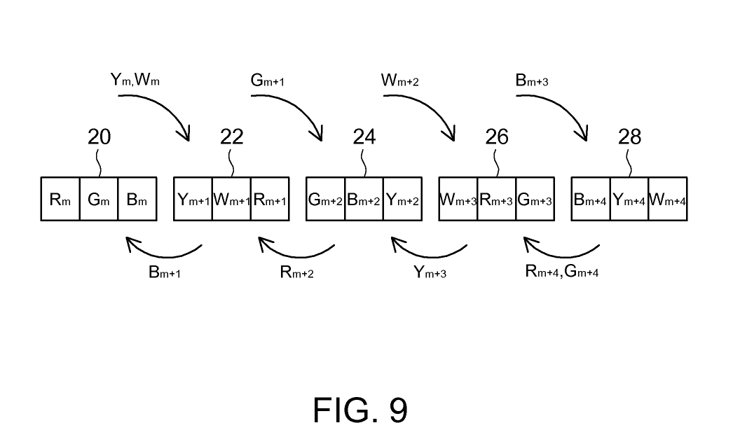

Referring to FIG. 9, a perspective of pixel data sharing according to a third embodiment of the invention is shown. The pixel data (Rₘ, Gₘ, Bₘ, Yₘ, Wₘ) of the selected pixel RGB 20 comprises a first value Rₘ, Gₘ, Bₘ belonging to the RGB sub-pixel color of the selected pixel 20 and a second value Yₘ, Wₘ not belonging to the RGB sub-pixel color of the selected pixel 20. The pixel data (Rₘ₊₁, Gₘ₊₁, Bₘ₊₁, Yₘ₊₁, Wₘ₊₁) of the selected pixel YWR 22 located to the right of the selected pixel 20 in the same row comprises a first value Yₘ₊₁, Wₘ₊₁, Rₘ₊₁ belonging to the YWR sub-pixel color of the selected pixel 22 and a second value Bₘ₊₁, Gₘ₊₁ not belonging to the YWR sub-pixel color of the selected pixel 22. Referring to FIG. 6, the selected pixel RGB 20 receives a third value Bₘ₊₁ inputted from the right neighboring selected pixel 22 wherein the third value Bₘ₊₁ does not belong to the YWR sub-pixel color of the neighboring selected pixel 22 but belongs to the RGB sub-pixel color of the selected pixel 20. Next, when the sub-pixel color corresponding to the third value Bₘ₊₁ is identical to the sub-pixel color corresponding to the first values Rₘ, Gₘ and Bₘ, the minimal value of the first value Bₘ and the third value Bₘ₊₁ is used as the data value B′ₘ=Min(Bₘ, Bₘ₊₁) of the sub-pixel color outputted from the selected pixel, and the remaining first values Rₘ and Gₘ are directly used as the data value of the remaining RG sub-pixels color outputted from the selected pixel 20. Thus, the sub-pixel data (Rₘ, Gₘ, Bₘ′) of the selected pixel RGB 20 uses [Rₘ, Gₘ, Min(Bₘ, Bₘ₊₁)] as the actually outputted value.

On the part of the selected pixel YWR 22, the first value is Yₘ₊₁, Wₘ₊₁, Rₘ₊₁. The selected pixel YWR 22 receives two third values Yₘ and Wₘ inputted from the left neighboring selected pixel RGB 20, wherein the third values Yₘ and Wₘ do not belong to the RGB sub-pixel color of the neighboring selected pixel 20 but belong to the YWR sub-pixel color of the selected pixel 22. At the same time, the selected pixel YWR 22 receives a third value Rₘ₊₂ inputted from the right neighboring selected pixel GBY 24, wherein the third value Rₘ₊₂ does not belong to the GBY sub-pixel color of the neighboring selected pixel 24 but belongs to the YWR sub-pixel color of the selected pixel 22. As the third value and the first value correspond to the sub-pixel color of the same color, the minimal value of the first values Yₘ₊₁, Wₘ₊₁ and Rₘ₊₁ and the third values Yₘ, Wₘ and Rₘ₊₂ of the selected pixel 22 is directly used as the data value of the sub-pixel color outputted from the selected pixel YWR 22. Thus, the sub-pixel data of the selected pixel YWR 22 uses [Min(Yₘ, Yₘ₊₁), Min(Wₘ, Wₘ₊₁), Min(Rₘ₊₁, Rₘ₊₂)] as the actually outputted value.

On the part of the selected pixel GBY 24, the first values are Gₘ₊₂, Bₘ₊₂ and Yₘ₊₂. The selected pixel GBY 24 receives a third value Gₘ₊₁ outputted from the left neighboring selected pixel YWR 22, wherein the third value Gₘ₊₁ does not belong to the YWR sub-pixel color of the selected pixel 22 but belongs to the GBY sub-pixel color of the selected pixel 24. At the same time, the selected pixel GBY 24 receives a third value Yₘ₊₃ inputted from the right neighboring selected pixel WRG 24, wherein the selected pixel GBY 24 does not belong to the WRG sub-pixel color of the selected pixel 24 but belongs to the GBY sub-pixel color of the selected pixel 26. When the sub-pixel color corresponding to the third value is identical to the sub-pixel color corresponding to the first value, the minimal value of the first value Gₘ₊₂, Yₘ₊₂ and the third value Gₘ₊₁, Yₘ₊₃ of the selected pixel 24 is used as the data value of the sub-pixel color outputted from the selected pixel GBY 24. Thus, the sub-pixel data of the selected pixel GBY 24 uses [Min(Gₘ₊₁, Gₘ₊₂), Bₘ₊₂, Min(Yₘ₊₂, Yₘ₊₃)] as the actually outputted value.

On the part of the selected pixel WRG 26, the first values are Wₘ₊₃, Rₘ₊₃ and Gₘ₊₃. The selected pixel WRG 26 receives a third value Wₘ₊₂ outputted from the left neighboring selected pixel GBY 24 and at the same time receives two of the third values Rₘ₊₄ and Gₘ₊₄ inputted from the right neighboring selected pixel BYW 28. As the sub-pixel color corresponding to the third value is identical to the sub-pixel color corresponding to the first value, the minimal value of the first values Wₘ₊₃, Rₘ₊₃ and Gₘ₊₃ and the third values Wₘ₊₂, Rₘ₊₄ and Gₘ₊₄ of the selected pixel 26 is directly used as the data value of the sub-pixel color outputted from the selected pixel WRG 26. Thus, the sub-pixel data of the selected pixel WRG 26 uses [Min(Wₘ₊₂, Wₘ₊₃), Min(Rₘ₊₃, Rₘ₊₄), Min(Gₘ₊₃, Gₘ₊₄),] as the actually outputted value.

On the part of the selected pixel BYW 28, the first values are Bₘ₊₄, Yₘ₊₄ and Wₘ₊₄. The selected pixel BYW 28 receives a third value Bₘ₊₃ inputted from the left neighboring selected pixel WRG 26. When the sub-pixel color corresponding to the third value is identical to the sub-pixel color corresponding to the first value, the minimal value of the first value Bₘ₊₄ and the third value Bₘ₊₃ of the selected pixel BYW 28 is directly used as the data value of the sub-pixel color outputted from the selected pixel BYW 28, and the first values Yₘ₊₄ and Wₘ₊₄ are used as the data value of the sub-pixel of remaining color outputted from the selected pixel BYW 28. Thus, the sub-pixel data of the selected pixel BYW 28 uses [Min(Bₘ₊₃, Bₘ₊₄), Yₘ₊₄, Wₘ₊₄] as the actually outputted value.

A practical example of an image processing method is illustrated below. Referring to FIG. 9, a perspective of an image processing method according to a second embodiment of the invention is shown. After the pixel data (Rₒ, Gₒ, Bₒ) executes data conversion according to the above formula, the pixel P₁ comprises a sub-pixel data (R₁, G₁, B₁, Y₁, W₁), the pixel P₂ comprises a sub-pixel data (R₂, G₂, B₂, Y₂, W₂), the pixel P₃ comprises a sub-pixel data (R₃, G₃, B₃, Y₃, W₃), the pixel P₄ comprises a sub-pixel data (R₄, G₄, B₄, Y₄, W₄), and the pixel P₅ comprises a sub-pixel data (R₅, G₅, B₅, Y₅, W₅), wherein the pixel data is stored in the register first.

A part of the converted sub-pixel data is directly used as the actually outputted sub-pixel data value, but another part of the converted sub-pixel data will be shared with the neighboring pixels first, and then the shared value is used as the actually outputted sub-pixel data value. On the part of the pixel P₁, the pixel P₁ comprises a red sub-pixel (R), a green sub-pixel (G) and a blue sub-pixel (B), wherein the actually outputted red sub-pixel data value R₁ and green sub-pixel data value G₁ are directly obtained from the R₁ and G₁ of the register, and the actually outputted blue sub-pixel value B₁′ is the minimal value of the B₁ and B₂ of the register. Lastly, the actually outputted sub-pixel data values of the pixel P₁ are [R₁, G₁, B₁′=min(B₁, B₂)], and the yellow and the white sub-pixels that are absent in the pixel P₁ are expressed by its neighboring pixel P₂ through data sharing.

On the part of the pixel P₂, the pixel P₂ comprises a yellow sub-pixel (Y), a white sub-pixel (W) and a red sub-pixel (R), wherein the actually outputted yellow sub-pixel value Y₂′ is the minimal value of Y₁ and Y₂ of the register, the actually outputted white sub-pixel value W₂′ is the minimal value of W₁ and W₂ of the register, and the actually outputted red sub-pixel value R₂′ is the minimal value of R₂ and R₃ of the register. Lastly, the actually outputted sub-pixel data value of the pixel P₂ is [Y₂′=min(Y₁, Y₂), W₂′=min(W₁, W₂), R₂′=min(R₂, R₃)], wherein the blue sub-pixel of the pixel P₂ is expressed as B₁′=min(B₁, B₂) by sharing the data of the blue sub-pixel data of the pixel P₁, and the green sub-pixel that is absent in the pixel P₂ is expressed by the pixel P₃ through data sharing.

On the part of the pixel P₃, the pixel P₃ comprises a green sub-pixel (G), a blue sub-pixel (B) and a yellow sub-pixel (Y), wherein the actually outputted green sub-pixel value G₃′ is the minimal value of G₂ and G₃ of the register, the actually outputted blue sub-pixel data value B₃ directly uses B₃ of the register, the actually outputted yellow sub-pixel value Y₃′ is the minimal value of Y₃ and Y₄ of the register. Lastly, the actually outputted sub-pixel data value of the pixel P₃ is [G₃′=min(G₂, G₃), B₃, Y₃′=min(Y₃, Y₄)], wherein the red sub-pixel of the pixel P₃ is expressed as R₂′=min(R₂, R₃) by sharing the data of the red sub-pixel of the pixel P₂, and the white sub-pixel that is absent in the pixel P₃ is expressed by the pixel P₄ through data sharing.

On the part of the pixel P₄, the pixel P₄ comprises a white sub-pixel (W), a red sub-pixel (R) and a green sub-pixel (G), wherein the actually outputted white sub-pixel value W₄′ is the minimal value of W₃ and W₄ of the register, the actually outputted red sub-pixel value R₄′ is the minimal value of R₄ and R₅ of the register, and the actually outputted green sub-pixel value G₄′ is the minimal value of G₄ and G₅ of the register. Lastly, the actually outputted sub-pixel data value of the pixel P₄ is [W₄′=min(W₃, W₄), R₄′=min(R₄, R₅), G₄′=min(G₄, G₅)], wherein the yellow sub-pixel of the pixel P₄ is expressed as Y₃′=min(Y₃, Y₄) by sharing the data of the yellow sub-pixel of the pixel P₃, and the blue sub-pixel that is absent in the pixel P₄ is expressed by the pixel P₅ through data sharing.

On the part of the pixel P₅, the pixel P₅ comprises a blue sub-pixel (B), a yellow sub-pixel (Y) and a white sub-pixel (W), wherein the actually outputted blue sub-pixel value B₄′ is the minimal value of B₄ and B₅ of the register, the actually outputted yellow sub-pixel data value Y₅ and white sub-pixel data value W₅ are directly obtained from Y₅, W₅ of the register. Lastly, the actually outputted sub-pixel data value of the pixel P₅ is [B₅′=min(B₄, B₅), Y₅, W₅], wherein the red sub-pixel of the pixel P₅ is expressed as R₄′=min(R₄, R₅) by sharing the red sub-pixel data of the pixel P₄, and the green sub-pixel of the pixel P₅ is expressed as G₄′=min(G₄, G₅) by sharing the green sub-pixel data of the pixel P₄. Thus, the pixel data P₅ is virtually expressed by five consecutive sub-pixel data (R₄′, G₄′, B₅′, Y₅, W₅) having five different colors. Likewise, the pixel data P₁ is virtually expressed by five sub-pixel data (R₁, G₁, B₁′, Y₂′, W₂′) having five different colors, the pixel data P₂ is virtually expressed by five sub-pixel data (B₁′, Y₂′, W₂′, R₂′, G₃′), the pixel data P₃ is virtually expressed by five consecutive sub-pixel data (R₂′, G₃′, B₃, Y₃′, W₄′), and the pixel data P₄ is virtually expressed by five consecutive sub-pixel data (Y₃′, W₄′, R₄′, G₄′, B₅′). Under the original circuit structure of the display panel, each item of pixel data is expressed by five colors, and both the color and the brightness are enhanced.

The first embodiment has the advantages of expanding the color gamut and increasing the contrast and sharpness. The image data processing method disclosed in the present embodiment of the invention achieves the same advantages and at the same time maintaining the original level of resolution.

The image processing method disclosed in the above embodiments of the invention converts an original image data (three-color data) into a four-color data to go with a display having a specific pixel array so that the re-defined pixel unit and the neighboring pixel unit share data and the shared data are further used as actually outputted value. Thus, resolution is maintained and color gamut is expanded without adding additional driving lines and driving chip. Under such structure, the color-enhancing sub-pixel data obtained according to the calculation formulas of the invention not only expands color gamut but also maintains pure-color display effect. Besides, the method for sharing the sub-pixel data disclosed in the above embodiment maintains the contrast and sharpness of image. Also, after the image data is converted into a five-color data, color gamut is expanded, pure color is maintained and brightness is increased.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures. For example, the invention is not limited to using the three primal colors RGB or converting the image data into a four-color or five-color data format. The image data can also be converted into a six-color data format (such as RGBCMY, RGBCMW, RGBMYW, RGBCYW, and so on) or a seven-color data format (such as RGBCMYW).

What is claimed is:

1. An image data conversion method, comprising:
receiving an original image data having three basic-color sub-pixel data;
calculating at least one color-enhancing sub-pixel data according to any two basic-color sub-pixel data so as to convert the original image data into an image data having at least the three basic-color sub-pixel data and the color-enhancing sub-pixel data, wherein the calculation of the color-enhancing sub-pixel data is represented as:
$${J}_{i} = [ var . - ( \frac{\vert {D}_{i} - {E}_{i} \vert}{S} ) ] \times Max ( {D}_{i} , {E}_{i} ) ; \qquad ( 1 )$$
wherein var.=0.8˜1.2, Dᵢ and Eᵢ denote two basic-color sub-pixel data, and S is the maximal grey level of the image data.

2. The method according to claim 1, wherein the three basic-color sub-pixels respectively are red sub-pixel, green sub-pixel and blue sub-pixel.

3. The method according to claim 1, wherein the color of the color-enhancing sub-pixel is a mixed color of any two of the three primal colors, the three primal colors being red (R), green (G), and blue (B).

4. The method according to claim 1, wherein when the color of the color-enhancing sub-pixel is yellow, Dᵢ and Eᵢ respectively denote red sub-pixel data and green sub-pixel data; when the color of the color-enhancing sub-pixel is cyan, Dᵢ and Eᵢ respectively denote green sub-pixel data and blue sub-pixel data; when the color of the color-enhancing sub-pixel is magenta, Dᵢ and Eᵢ respectively denote red sub-pixel data and blue sub-pixel data.

5. The method according to claim 1, wherein the three basic-color sub-pixels respectively are cyan (C) sub-pixel, magenta (M) sub-pixel, and yellow (Y) sub-pixel.

6. The method according to claim 1 further comprising:
forming a display pixel array by three basic-color sub-pixels and at least one color-enhancing sub-pixel, any three of the four sub-pixels constituting a selected pixel, wherein the converted image data comprises a first value belonging to the sub-pixel color of the selected pixel and a second value not belonging to the sub-pixel color of the selected pixel;
the selected pixel receiving a third value inputted from the at least one neighboring selected pixel, wherein the third value does not belong to the sub-pixel color of the neighboring selected pixel but belongs to the sub-pixel color of the selected pixel;
using the minimal value of the first value and the third value as the data value of the sub-pixel color outputted from the selected pixel when the sub-pixel color corresponding to the third value is identical to the sub-pixel color corresponding to the first value; and
using the first value as the data value of the remaining sub-pixel color outputted from the selected pixel.

7. The method according to claim 1 further comprising:
using the minimal value of the three basic-color sub-pixel data as another color-enhancing sub-pixel data, and adjusting the three basic-color sub-pixel data according to the another color-enhancing sub-pixel data, wherein the adjusted values of the three basic-color sub-pixel data respectively are:
$${D}_{i}^{′} = {D}_{i} \times m - {K}_{i}$$
$${E}_{i}^{′} = {E}_{i} \times m - {K}_{i}$$
$${F}_{i}^{′} = {F}_{i} \times m - {K}_{i} , \\ wherein m = 1 + \frac{Max ( {D}_{i} , {E}_{i} , {F}_{i} )}{Min ( {D}_{i} , {E}_{i} , {F}_{i} )} ;$$
Kᵢ denotes the another color-enhancing sub-pixel data; and
Dᵢ, Eᵢ, and Fᵢ respectively denote the three basic-color sub-pixel data.

8. The method according to claim 7, wherein the color of the another color-enhancing sub-pixel is white.

9. The method according to claim 7, wherein the method further comprises:
forming a display pixel array by the three basic-color sub-pixels and at least two color-enhancing sub-pixel, any three of the five sub-pixels constituting a selected pixel, wherein the adjusted three basic-color sub-pixel data and the two color-enhancing sub-pixel data comprise a first value belonging to the sub-pixel color of the selected pixel and a second value not belonging to the sub-pixel color of the selected pixel;
the selected pixel receiving a third value inputted from the at least one neighboring selected pixel, wherein the third value does not belong to the neighboring sub-pixel color of the neighboring selected pixel but belongs to the sub-pixel color of the selected pixel;
using the minimal value of the first value and the third value as the data value of the sub-pixel color outputted from the selected pixel when the sub-pixel color corresponding to the third value is identical to the sub-pixel color corresponding to the first value; and
using the first value as the data value of the remaining sub-pixel color outputted from the selected pixel.

10. The method according to claim 7, wherein the neighboring selected pixel is situated next to the selected pixel in the first dimension.

11. An image processing method, comprising:
receiving an original image data having three basic-color sub-pixel data;
calculating at least one color-enhancing sub-pixel data according to any two basic-color sub-pixel data so as to convert the original image data into an image data having at least the three basic-color sub-pixel data and the color-enhancing sub-pixel data, wherein the calculation of the color-enhancing sub-pixel data is represented as:
$${J}_{i} = [ var . - ( \frac{\vert {D}_{i} - {E}_{i} \vert}{S} ) ] \times Max ( {D}_{i} , {E}_{i} ) ; \qquad ( 1 )$$
wherein var.=0.8˜1.2, Dᵢ and Eᵢ denote any two basic-color sub-pixel data of the original image data, and S is the maximal grey level of the image data;
forming a display pixel array by three basic-color sub-pixels and at least one color-enhancing sub-pixel, any three of these sub-pixels constituting a selected pixel, wherein the converted image data comprises a first value belonging to the sub-pixel color of the selected pixel and a second value not belonging to the sub-pixel color of the selected pixel;
the selected pixel receiving a third value inputted from the at least one neighboring selected pixel, wherein the third value does not belong to the neighboring sub-pixel color of the neighboring selected pixel but belongs to the sub-pixel color of the selected pixel;
using the minimal value of the first value and the third value as the data value of the sub-pixel color outputted from the selected pixel when the sub-pixel color corresponding to the third value is identical to the sub-pixel color corresponding to the first value; and
using the first value as the data value of the remaining sub-pixel color outputted from the selected pixel.

12. The method according to claim 11, wherein the three basic-color sub-pixels are red sub-pixel, green sub-pixel, and blue sub-pixel, and the color of the color-enhancing sub-pixel is a mixed color of any two of the three primal colors, the three primal colors being red (R), green (G), and blue (B).

13. The method according to claim 11, wherein when the color of the color-enhancing sub-pixel is yellow, Dᵢ and Eᵢ respectively are red sub-pixel data and green sub-pixel data: when the color of the color-enhancing sub-pixel is cyan, Dᵢ and Eᵢ respectively are green sub-pixel data and blue sub-pixel data; when the color of the color-enhancing sub-pixel is magenta, Dᵢ and Eᵢ respectively are red sub-pixel data and blue sub-pixel data.

14. The method according to claim 11, wherein the three basic-color sub-pixels are cyan (C), magenta (M), and yellow (Y) sub-pixel.

15. The method according to claim 11 further comprising:
using the minimal value of the three basic-color sub-pixel data as another color-enhancing sub-pixel data, and adjusting the three basic-color sub-pixel data according to the another color-enhancing sub-pixel data, wherein the adjusted values of the three basic-color sub-pixel data respectively are:
$${D}_{i}^{′} = {D}_{i} \times m - {K}_{i}$$
$${E}_{i}^{′} = {E}_{i} \times m - {K}_{i}$$
$${F}_{i}^{′} = {F}_{i} \times m - {K}_{i} , \\ wherein m = 1 + \frac{Max ( {D}_{i} , {E}_{i} , {F}_{i} )}{Min ( {D}_{i} , {E}_{i} , {F}_{i} )} ;$$
Kᵢ denotes the another color-enhancing sub-pixel data; and
Dᵢ, Eᵢ and Fᵢ respectively denote the three basic-color sub-pixel data.

16. The method according to claim 15, wherein the color of the another color-enhancing sub-pixel is white.

17. The method according to claim 15, wherein the display pixel array is formed by the three basic-color sub-pixels and two color-enhancing sub-pixels, and the selected pixel of the pixel array is formed by any three of the five sub-pixels;
wherein the adjusted three basic-color sub-pixel data and the two color-enhancing sub-pixel data comprise a first value belonging to the sub-pixel color of the selected pixel and a second value not belonging to the sub-pixel color of the selected pixel.

18. An image data conversion device, comprising;
a first subtractor used for receiving the three basic-color sub-pixel data of an original image data and calculating a difference between any two selected basic-color sub-pixel data;
an absolute value extractor used for receiving the difference and taking a absolute value of the difference;
a divider used for receiving the absolute value and dividing the absolute value by the maximal grey level to obtain a quotient;
a second subtractor used for calculating a difference between a variable and the quotient as a parameter, wherein the variable ranges between 0.8˜1.2;
a maximal value extractor used for obtaining the maximal of the two selected basic-color sub-pixel data;
a multiplier used for multiplying the maximal of the two selected basic-color sub-pixel data by the parameter and using the product as a color-enhancing sub-pixel data.

19. The device according to claim 18, wherein the three basic-color sub-pixels is red (R), green (G), and blue sub-pixel, and the color of the color-enhancing sub-pixel is a mixed color of any two of the three primal colors, the three primal colors being red (R), green (G), and blue (B).

20. The device according to claim 18, wherein the color of the color-enhancing sub-pixel is selected from yellow, cyan and magenta.
